(19) United States
(12) Patent Application Publication
(10) Pub. No.: US 2012/0152660 A1
(43) Pub. Date: Jun. 21, 2012

(54) ELEVATOR SYSTEM

(75) Inventors: Yuji Fujihata, Tokyo (JP); Masaaki Amano, Tokyo (JP)

(73) Assignee: Mitsubishi Electric Corporation, Tokyo (JP)

(21) Appl. No.: 13/393,010

(22) PCT Filed: Nov. 11, 2009
(86) PCT No.: PCT/JP2009/069201

§ 371 Date: Feb. 28, 2012

(51) Int. Cl. B66B 1/18

(52) U.S. Cl. 187/381

(57) ABSTRACT

An elevator system including a hall-installed call registration device installed in a hall of an elevator, and an automatic call registration device installed in a place more away from the hall than the hall-installed call registration device. In a case the same personal information as the personal information inputted to the hall-installed call registration device is inputted to the automatic call registration device within a given period of time before input to the hall-installed call registration device, a determination is made as to whether or not a destination floor of the automatically registered destination call and a destination floor of the manually registered destination call along with input of the personal information are in agreement with each other. If the two are not in agreement with each other, the destination call automatically registered from the automatic call registration device is canceled.

### TECHNICAL FIELD

The present invention relates to an elevator system which performs the operation control of a plurality of elevators.

### BACKGROUND ART

Some elevator systems which perform the operation control of a plurality of elevators enable an elevator user to register a destination call before boarding a car. For example, the elevator system described in Patent Literature 1 below is configured in such a manner that personal information is obtained from the card or the like of a user, whereby a destination call corresponding to the destination floor which the user has registered beforehand is automatically registered on the basis of the obtained personal information.

### CITATION LIST

### Patent Literature

Patent Literature 1: Japanese Patent Laid-Open No. H8-81143

### SUMMARY OF INVENTION

### Technical Problem

In conventional elevator systems including the elevator system described in Patent Literature 1, when a user who has automatically registered a destination call registers thereafter a different destination call in order to change his or her destination, elevator assignment is performed to the destination call which the above-described user registered later irrespective of the automatically registered destination call. For this reason, useless call registration occurs, posing the problem that optimum operation control of elevators cannot be performed.

That is, the elevator to which the automatically registered destination call is assigned stops at a floor where nobody among the users gets out of the car and, therefore, the operation efficiency decreases remarkably. Also, since useless call registration occurs, optimum assignment is not always performed to the destination call registered thereafter.

Incidentally, such problems can occur not only in the case where an automatically registered destination call is changed, but also for example in the case where after the automatic registration of a destination call, for some reason, an elevator user re-registers the same destination call.

The present invention was made to solve the problems as described above, and an object of the invention is to provide an elevator system capable of carrying out optimum operation control of elevators even when the same user has registered a plurality of destination calls.

### Solution to Problem

An elevator system of the invention is an elevator system which performs operation control of a plurality of elevators. The elevator system comprises a hall-installed call registration device which is provided in a hall of an elevator and by use of which a user performs input of his or her personal information and manual registration of a destination call before boarding an elevator car, an automatic call registration device which is provided in a place more away from the hall than the hall-installed call registration device and by use of which a user performs automatic registration of a destination call by inputting his or her personal information before boarding an elevator car, and cancel means which, in a case where same personal information as the personal information inputted to the hall-installed call registration device is inputted to the automatic call registration device within a given period of time before input to the hall-installed call registration device, cancels a destination call automatically registered from the automatic call registration device unless a destination floor of the automatically registered destination call and a destination floor of the manually registered destination call along with input of the personal information are in agreement with each other.

Also, an elevator system of the invention is an elevator system which performs operation control of a plurality of elevators. The elevator system comprises a hall-installed call registration device which is provided in a hall of an elevator and by use of which a user performs input of his or her personal information and manual registration of a destination call before boarding an elevator car, an automatic call registration device which is provided in a place more away from the hall than the hall-installed call registration device and by use of which a user performs automatic registration of a destination call by inputting his or her personal information before boarding an elevator car, and assigned car determination means which, in a case where same personal information as the personal information inputted to the hall-installed call registration device is inputted to the automatic call registration device within a given period of time before input to the hall-installed call registration device, assigns a destination call manually registered from the hall-installed call registration device to a same elevator as the elevator to which a destination call automatically registered from the automatic call registration device is assigned if a destination floor of the automatically registered destination call and a destination floor of the manually registered destination call along with input of the personal information are in agreement with each other.

Also, an elevator system of the invention is an elevator system which performs operation control of a plurality of elevators. The elevator system comprises a hall-installed call registration device which is provided in a hall of an elevator and by use of which a user performs input of his or her personal information and manual registration of a destination call before boarding an elevator car, an automatic call registration device which is provided in a place more away from the hall than the hall-installed call registration device and by use of which a user performs automatic registration of a destination call by inputting his or her personal information before boarding an elevator car, and cancel means which, in a case where same personal information as the personal information inputted to the hall-installed call registration device is inputted to the automatic call registration device within a given period of time before input to the hall-installed call registration device, cancels a destination call manually registered from the hall-installed call registration device if a destination floor of the automatically registered destination call and a destination floor of the manually registered destination call along with input of the personal information are in agreement with each other.

### Advantageous Effect of Invention

According to the present invention, it is ensured that an elevator system which performs the operation control of a plurality of elevators can carry out optimum operation control of elevators even when the same user has registered a plurality of destination calls.

### BRIEF DESCRIPTION OF DRAWINGS

FIG. 1 is a plan view showing an elevator system in a first embodiment according to the present invention.

FIG. 2 is a block diagram showing an elevator system in the first embodiment according to the present invention.

FIG. 3 is a flowchart showing the actions of the elevator system in the first embodiment according to the present invention.

### DESCRIPTION OF EMBODIMENTS

The present invention will be described in more detail with reference to the accompanying drawings. Incidentally, in each of the drawings, like numerals refer to like or corresponding parts and redundant descriptions of these parts are appropriately simplified or omitted.

### First Embodiment

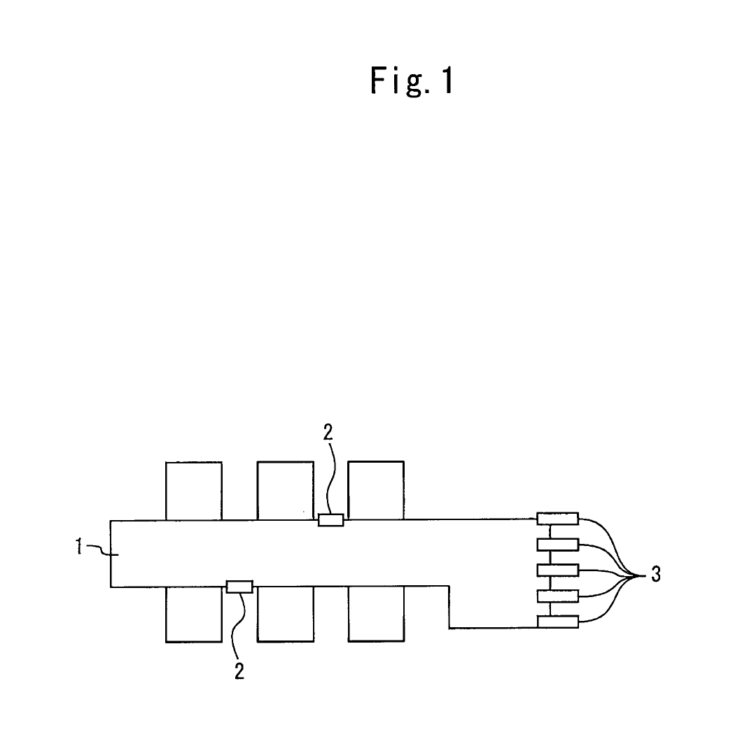

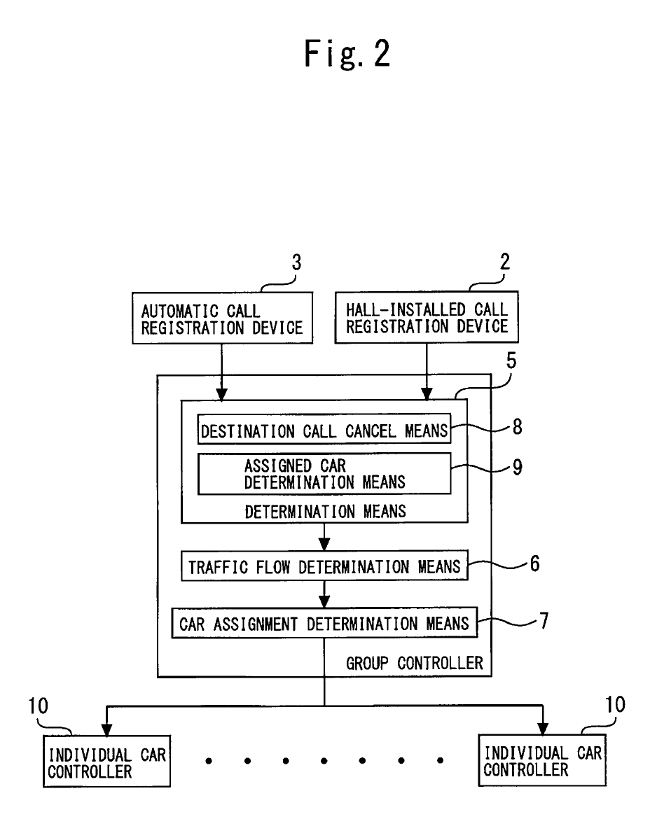

FIG. 1 is a plan view showing an elevator system in a first embodiment according to the present invention. FIG. 2 is a block diagram showing an elevator system in the first embodiment according to the present invention. This elevator system performs the operation control of a plurality of elevators. FIG. 1 shows the case where this elevator system performs the group control of six elevators, as an example.

In FIGS. 1 and 2, reference numeral 1 denotes a hall of an elevator and reference numeral 2 denotes a hall-installed call registration device which is installed in the elevator hall 1. The hall-installed call registration device 2 is intended as a device by use of which an elevator user registers his or her destination call by a manual operation before boarding an elevator car. This hall-installed call registration device 2 has also the function by use of which a user inputs his or her personal information during the registration of a destination call.

The above-described hall-installed call registration device 2 is provided with, for example, an authentication device which performs personal authentication, an input unit by use of which a user manually inputs a destination floor, and guidance equipment (for example, a display, a speaker or the like) which provides various kinds of information to the user. The authentication device reads the personal information (ID) of a user and checks that information against the pre-registered information (user ID data). For example, the ID number which is stored in a key, a card, an IC tag or the like or biometric information, such as a fingerprint, a vein pattern, a voice print or an iris pattern, is used as the personal information for identifying users. The above-described input unit has such a configuration that in normal times the input operation of a destination floor cannot be performed and the operation becomes effective, i.e., the input of a destination floor is possible only within a given period of time when personal authentication has been carried out by the authentication device. When the input operation of a destination floor is carried out in the period during which the above-described operation is effective, the hall-installed call registration device 2 associates inputted personal information (or information corresponding thereto) with destination floor information, and transmits the information to the group controller 4, which will be described later.

The above-described configuration of the hall-installed call registration device 2 is only an example, and the configuration thereof is not limited to the above-described one. For example, the hall-installed call registration device 2 may have a configuration which enables a selection to be made between the input and non-input of personal information.

Reference numeral 3 denotes an automatic call registration device which is provided in a place more away from the hall 1 than the hall-installed call registration device 2. This automatic call registration device 3 is intended as a device by use of which an elevator user performs automatic registration of a destination call by inputting his or her personal information before boarding the elevator car.

The above-described automatic call registration device 3 is provided with, for example, an authentication device which performs personal authentication, a registration device for automatically registering a destination call corresponding to the user for whom the authentication device has performed personal authentication, and guidance equipment (for example, a display, a speaker or the like) which provides various kinds of information to the user. The functions of the authentication device and guidance equipment are the same as those provided in the hall-installed call registration device 2. Furthermore, the destination floor information corresponding to the personal information (user ID data) of each user is stored in the above-described registration device. When personal authentication has been carried out by the authentication device, on the basis of the personal information for which personal authentication has been carried out, the registration device identifies the destination floor of the user, associates inputted personal information (or information corresponding thereto) with identified destination floor information, and transmits the information to the group controller 4, which will be described later.

FIG. 1 shows the case where the automatic call registration device 3 is provided integrally with a security gate, as an example. This security gate is installed, for example, in a passage or the like on which the user must inevitably pass when entering the hall 1. That is, on the basis of the personal information which is inputted by the user in order to open the security gate, the automatic call registration device 3 carries out the control for automatically registering a destination call. For this reason, in the elevator system shown in FIG. 1, when personal authentication is carried out, both actions of security gate opening and automatic registration of a destination call are performed.

The group controller 4 has the function of registering a destination call on the basis of the input information from the hall-installed call registration device 2 and the automatic call registration device 3 and assigning an optimum elevator (car) to the registered destination call. This group controller 4 appropriately controls the whole system so that an optimum operation control of the elevator is performed even in the case where the same user has registered a plurality of destination calls in a short period. To realize this function, the group controller 4 is provided with determination means 5, traffic flow determination means 6 and car assignment determination means 7.

The determination means 5 has the function of making a determination as to whether or not the same user has registered a plurality of destination calls within a given period of time. Specifically, on the basis of each piece of input information from the hall-installed call registration device 2 and the automatic call registration device 3 the determination means 5 makes a determination as to whether or not the same personal information as the personal information inputted to the hall-installed call registration device 2 has been inputted to the automatic call registration device 3 within a given period of time before input to the hall-installed call registration device 2. When it is determined by this determination that the same personal information has been inputted, the determination means 5 makes a determination as to whether or not a destination floor of the automatically registered destination call and a destination floor of the manually registered destination call along with the personal information are in agreement with each other.

Then, on the basis of the result of the above-described determination as to agreement by the determination means 5, destination call cancel means 8 and assigned car determination means 9 perform appropriate processing of the two destination calls registered within the above-described given period of time. Specifically, when it is determined by the determination means 5 that the destination floors are not in agreement with each other, the destination call cancel means 8 cancels the destination call automatically registered within the above-described given period of time from the automatic call registration device 3 (the destination call registered earlier). On the other hand, when it is determined by the determination means 5 that the destination floors are in agreement with each other, the assigned car determination means 9 assigns the destination call manually registered within the above-described given period of time from the hall-installed call registration device 2 (the destination call registered later) to the same elevator as the elevator to which the destination call automatically registered from the automatic call registration device 3 (the destination call registered earlier) is assigned.

The traffic flow determination means 6 has the function of detecting the traffic flow of each elevator. The car assignment determination means 7 has the function of assigning a car to a destination call. That is, on the basis of the traffic flow of each elevator detected by the traffic flow determination means 6, the car assignment determination means 7 assigns an appropriate elevator (car) to a registered destination call.

Incidentally, concrete operation control of each elevator is performed by an individual car controller 10. This individual car controller 10 appropriately controls the whole operation of an elevator including a car by receiving assignment information and commands concerning destination floors from the group controller 4.

The components of the elevator system shown in FIGS. 1 and 2, i.e., the hall-installed call registration device 2, the automatic call registration device 3, the group controller 4, and the individual car controller 10 are connected by a network and are configured to be able to carry out information communications with each other.

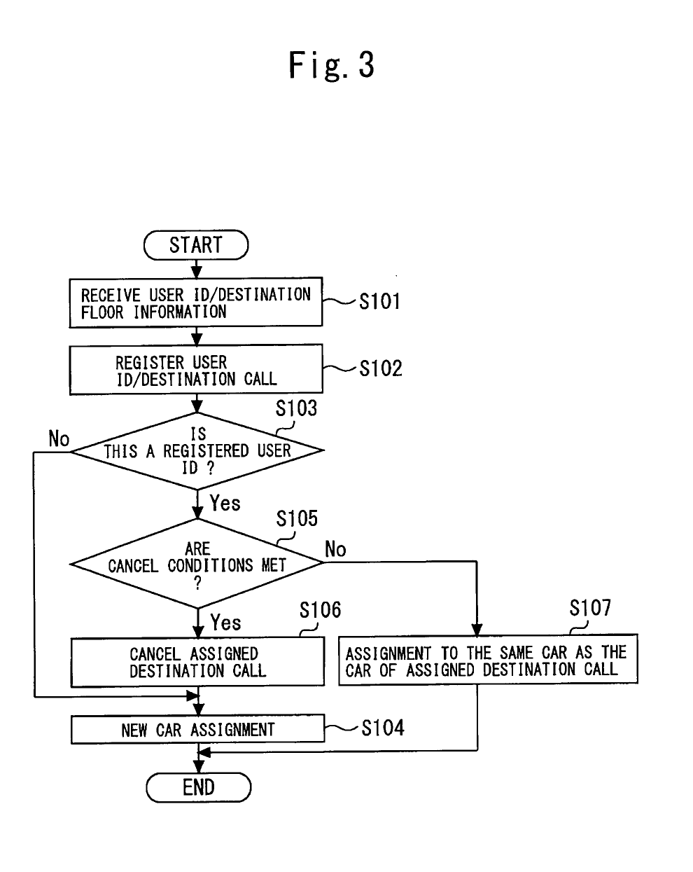

Next, on the basis of FIG. 3, a description will be given of concrete actions of the elevator system having the above-described configuration. FIG. 3 is a flowchart showing the actions of the elevator system in the first embodiment according to the present invention.

A user registers a destination call from the automatic call registration device 3 or the hall-installed call registration device 2 with accompanying input of his or her personal information, whereby the personal information (user ID) and destination floor information of the user are transmitted to the group controller 4 (S101). When in the group controller 4 the destination call and the personal information corresponding to the destination call are registered on the basis of the information from the automatic call registration device 3 and the hall-installed call registration device 2 (S102), the determination means 5 makes a determination as to whether or not the registered personal information is in agreement with any piece of the personal information registered within a given period of time immediately before that (S103). That is, in S103 the determination means 5 makes a determination as to whether or not the same user has carried out the registration of destination calls successively within the above-described given period of time.

For example, in the case where a user passes through the security gate and carries out the automatic registration of a destination call from the automatic call registration device 3, a determination of No is made in S103 if the use of the elevator is carried out for the first time this day (unless the registration of a destination call is carried out within the given period of time immediately before that). On the other hand, in the case where the user manually registers a destination call from the hall-installed call registration device 2 after passing through the security gate, a destination call automatically registered immediately before that exists and hence a determination of Yes is made in S103.

Incidentally, the above-described given period of time for making a determination as to whether or not one user has registered a plurality of destination calls is defined as, for example, the moving time of the user. This moving time is a time, for example, obtained by adding the walking time (the time required by the user in moving (walking) from the automatic call registration device 3 to the hall-installed call registration device 2) and the margin time (the time required by the user in manually registering a destination call from the hall-installed call registration device 2 after arrival at the hall 1 (1 to 5 seconds or so)).

When the determination of No is made in S103, the group controller 4 assigns an elevator to the destination call registered in S102 (S104).

On the other hand, when the determination of Yes is made in S103, next, the group controller 4 makes a determination as to whether or not the cancel conditions for the destination call cancel means 8 to cancel a destination call are met (S105).

That is, concerning the two destination calls registered along with input of the above-described personal information (the destination call registered in S102 and the destination call already registered before that), the determination means 5 makes a determination as to whether or not the destination floors are in agreement with each other. For example, in the above-described example, the determination means 5 makes a determination as to whether or not the destination floor of the destination call manually registered by the above-described user from the hall-installed call registration device 2 is in agreement with the destination floor of the destination call automatically registered during the passing of the user through the security gate.

Then, in the case where in S105 the cancel conditions are met, that is, when the compared destination floors are not in agreement with each other, the destination call cancel means 8 cancels the destination call for which elevator assignment has already been carried out (the destination call automatically registered from the automatic call registration device 3) (S106). Furthermore, the group controller 4 newly assigns a car to the destination call registered in S102 (the destination call manually registered from the hall-installed call registration device 2) (S104).

On the other hand, in the case where in S105 the cancel conditions are not met, that is, when the compared destination floors are in agreement with each other, the assigned car determination means 9 assigns the destination call registered in S102 to the same car as the car to which the destination call has already been assigned (S107).

According to the first embodiment of the present invention, in the elevator system which performs the operation control of a plurality of elevators, it is possible to realize optimum operation control of the elevators even when the same user registers a plurality of destination calls.

That is, when the destination floors of the two destination calls registered by one user are not in agreement with each other, the destination call registered earlier is canceled at the timing when this user registers the second destination call. For this reason, for example, when the user wants to change the destination call automatically registered during the passing through the security gate (when the user wants to move to a floor different from the destination floor registered by the user beforehand), this user can cancel the automatically registered destination call and register a desired destination call by manually registering a destination call from the hall-installed call registration device 2 in the hall 1.

When the destination floors of the two destination calls registered by one user are in agreement with each other, the destination call registered later by this user is assigned to the same elevator as the elevator to which the destination call already registered is assigned. For this reason, for example, even when the user re-registers the destination call of the same destination floor from the hall-installed call registration device 2 by mistake or by being convinced that automatic registration has not been carried out, there is no possibility that a decrease in the operation efficiency might not be induced thereby.

Incidentally, in this embodiment, the description has been given of the case where the destination floor information of the user is stored beforehand in the automatic call registration device 3. However, the destination floor information may also be stored in the ID card or the like of the user. In this case, the automatic call registration device 3 is configured to simultaneously perform also the reading of the destination floor information in reading the personal information of the user, for example.

### Second Embodiment

In this embodiment, the configuration is made such that when it is determined by the determination means 5 that the destination floors are in agreement with each other, the destination call cancel means 8 (or second destination call cancel means) cancels the destination call manually registered from the hall-installed call registration device 2 (the destination call registered later).

That is, on the basis of each piece of inputted information from the hall-installed call registration device 2 and the automatic call registration device 3, the determination means 5 makes a determination as to whether or not the same personal information as the personal information inputted to the hall-installed call registration device 2 has been inputted to the automatic call registration device 3 within a given period of time before input to the hall-installed call registration device 2. When the determination means 5 determines by this determination that the same personal information has been inputted, then the determination means 5 makes a determination as to whether or not the destination floor of the automatically registered destination call and the destination floor of the manually registered destination call along with the personal information are in agreement with each other.

When it is determined by the determination means 5 that the destination floors are not in agreement with each other, the destination call cancel means 8 cancels the destination call automatically registered from the automatic call registration device 3 within the above-described given period of time (the destination call registered earlier). Also, when it is determined by the determination means 5 that the destination floors are in agreement with each other, the destination call cancel means 8 cancels the destination ca11 manually registered from the hall-installed call registration device 2 within the above-described given period of time (the destination call registered later).

The other respects of configuration are the same as in the first embodiment.

The above described configuration can also provide the same effect as that of the first embodiment. That is, even when the user re-registers the destination call of the same destination floor from the hall-installed call registration device 2 by mistake or by being convinced that automatic registration has not been carried out, this manually registered destination call is canceled at the timing when the destination call is manually registered by the user. For this reason, useless call registration does not occur, nor there is possibility that a decrease in the operation efficiency might be induced.

### INDUSTRIAL APPLICABILITY

The elevator group control device of the present invention can be applied to those in which a user registers a destination call by inputting his or her personal information before boarding the elevator.

### REFERENCE SIGNS LIST

1 hall

2 hall-installed call registration device

3 automatic call registration device

4 group controller

5 determination means

6 traffic flow determination means

7 car assignment determination means

8 destination call cancel means

9 assigned car determination means

10 individual car controller

1-6. (canceled)

7. An elevator system which performs operation control of a plurality of elevators, comprising:
a hall-installed call registration device which is provided in a hall of an elevator and by use of which a user performs input of his or her personal information and manual registration of a destination call before boarding an elevator car;
an automatic call registration device which is provided in a place more away from the hall than the hall-installed call registration device and by use of which a user performs automatic registration of a destination call by inputting his or her personal information before boarding an elevator car; and
a cancel device which, in a case where same personal information as the personal information inputted to the hall-installed call registration device is inputted to the automatic call registration device within a given period of time before input to the hall-installed call registration device, cancels a destination call automatically registered from the automatic call registration device unless a destination floor of the automatically registered destination call and a destination floor of the manually registered destination call along with input of the personal information are in agreement with each other.

8. The elevator system according to claim 7, further comprising:
an assigned car determination device which, in the case where the same personal information as the personal information inputted to the hall-installed call registration device is inputted to the automatic call registration device within the given period of time before input to the hall-installed call registration device, assigns a destination call manually registered from the hall-installed call registration device to a same elevator as the elevator to which a destination call automatically registered from the automatic call registration device is assigned if a destination floor of the automatically registered destination call and a destination floor of the manually registered destination call along with input of the personal information are in agreement with each other.

9. The elevator system according to claim 7, further comprising:
a second cancel device which, in the case where the same personal information as the personal information inputted to the hall-installed call registration device is inputted to the automatic call registration device within the given period of time before input to the hall-installed call registration device, cancels a destination call manually registered from the hall-installed call registration device if a destination floor of the automatically registered destination call and a destination floor of the manually registered destination call along with input of the personal information are in agreement with each other.

10. The elevator system according to claim 7, wherein the automatic call registration device is provided integrally with a security gate through which users must pass in entering the hall and performs automatic registration of a destination call on the basis of the personal information inputted to open the security gate.

11. An elevator system which performs operation control of a plurality of elevators, comprising:
a hall-installed call registration device which is provided in a hall of an elevator and by use of which a user performs input of his or her personal information and manual registration of a destination call before boarding an elevator car;
an automatic call registration device which is provided in a place more away from the hall than the hall-installed call registration device and by use of which a user performs automatic registration of a destination call by inputting his or her personal information before boarding an elevator car; and
an assigned car determination device which, in a case where same personal information as the personal information inputted to the hall-installed call registration device is inputted to the automatic call registration device within a given period of time before input to the hall-installed call registration device, assigns a destination call manually registered from the hall-installed call registration device to a same elevator as the elevator to which a destination call automatically registered from the automatic call registration device is assigned if a destination floor of the automatically registered destination call and a destination floor of the manually registered destination call along with input of the personal information are in agreement with each other.

12. The elevator system according to claim 11, wherein the automatic call registration device is provided integrally with a security gate through which users must pass in entering the hall and performs automatic registration of a destination call on the basis of the personal information inputted to open the security gate.

13. An elevator system which performs operation control of a plurality of elevators, comprising:
a hall-installed call registration device which is provided in a hall of an elevator and by use of which a user performs input of his or her personal information and manual registration of a destination call before boarding an elevator car;
an automatic call registration device which is provided in a place more away from the hall than the hall-installed call registration device and by use of which a user performs automatic registration of a destination call by inputting his or her personal information before boarding an elevator car; and
a cancel device which, in a case where same personal information as the personal information inputted to the hall-installed call registration device is inputted to the automatic call registration device within a given period of time before input to the hall-installed call registration device, cancels a destination call manually registered from the hall-installed call registration device if a destination floor of the automatically registered destination call and a destination floor of the manually registered destination call along with input of the personal information are in agreement with each other.

14. The elevator system according to claim 13, wherein the automatic call registration device is provided integrally with a security gate through which users must pass in entering the hall and performs automatic registration of a destination call on the basis of the personal information inputted to open the security gate.
